(19) United States
(12) Patent Application Publication
(10) Pub. No.: US 2005/0046116 A1
(43) Pub. Date: Mar. 3, 2005

(54) Cylinder-head gasket comprising an edge-to-edge stop ring

(76) Inventor: Christian Kebaili, Limoges (FR)

Correspondence Address: HARNESS, DICKEY & PIERCE, P.L.C., P.O. BOX 828, BLOOMFIELD HILLS, MI, 48303, US

(21) Appl. No.: 10/484,546

(22) PCT Filed: Jul. 22, 2002
(86) PCT No.: PCT/FR02/02619

(30) Foreign Application Priority Data
Jul. 23, 2001 (FR) 01/09809

(51) Int. Cl. F02F 11/00

(52) U.S. Cl. 277/591

(57) ABSTRACT

The invention concerns a head-cylinder gasket with at least an opening (14) corresponding to a combustion chamber, comprising a so-called outer plate (12) including a circular rib (16), surrounding the opening (14), arranged at a distance d from the edge of said opening (14), and a support plate (18) arranged against the surface of the outer plate (12) bearing the rib (16) in projection, including an opening with a diameter larger than the opening (14) of the outer plate so as to define a space wherein is arranged a stop ring (20) in the form of an annular wedge with an internal diameter corresponding to that of the opening (14) and an external diameter substantially adjusted to the opening of the support plate so as to be arranged edge-to-edge. The invention is characterised in that it comprises an element (24) interposed between the stop ring (20) and the support plate maintaining said stop ring.

The present invention relates to a gasket, particularly a cylinder head gasket comprising an edge-to-edge stopper. More particularly, the present invention concerns a multisheet head gasket comprising at least two sheets of which at least one is ribbed.

According to one embodiment, the head gasket comprises two sheets with at least one opening corresponding to the opening of a combustion chamber, at least one of the two sheets, and preferably both, comprising a rib disposed around each opening at a distance from the edge of said opening, said ribs being deformed toward the interior of the gasket.

In addition, the gasket comprises an intermediate support sheet interposed between the two external sheets and opposite the ribs as well as a stopper in the form of an annular lining having an internal diameter approximately corresponding to that of the opening and an external diameter smaller than that of the ribs, said stopper being disposed edge-to-edge along the extension of the support sheet.

The connection between the stopper and the support sheet is generally made by welding, gluing or the like. French patent application FR-00.12669 filed in the name of Applicant proposes a process for fixing the stopper to the support sheet by radial expansion of said stopper.

The present invention proposes a novel cylinder head gasket comprising an edge-to-edge stopper with a new stopper/support sheet connection that provides better support for said stopper.

To this end, the object of the invention is a cylinder head gasket with at, least one opening corresponding to a combustion chamber and comprising, on the one hand, at least two external sheets of which at least one comprises a circular rib that surrounds the opening and is disposed at a distance d from the edge of said opening and, on the other hand, a support sheet disposed between the external sheets and having an opening with a diameter that is greater than the opening of the external sheets so as to define a space wherein is disposed a stopper in the form of an annular lining with an internal diameter corresponding to that of the opening and an external diameter approximately adjusted to the opening of the support sheet so as to be disposed from edge to edge, characterized in that it comprises an element interposed between the stopper and the support sheet to ensure the support of said stopper.

According to one embodiment, the element interposed between the stopper and the support sheet is in the form of a rivet provided at each end with a border folded down against the faces of the support sheet and the stopper so as to grip them and to limit their relative movements.

Advantageously, the stopper comprises at its periphery at least one tab at the level of which is disposed the support element.

According to another embodiment a forced-in pin is interposed by force between the stopper and the support sheet.

Other features and advantages will become apparent from the following description of the device of the invention, the description being provided only as an example and referring to the drawings attached herewith in which:

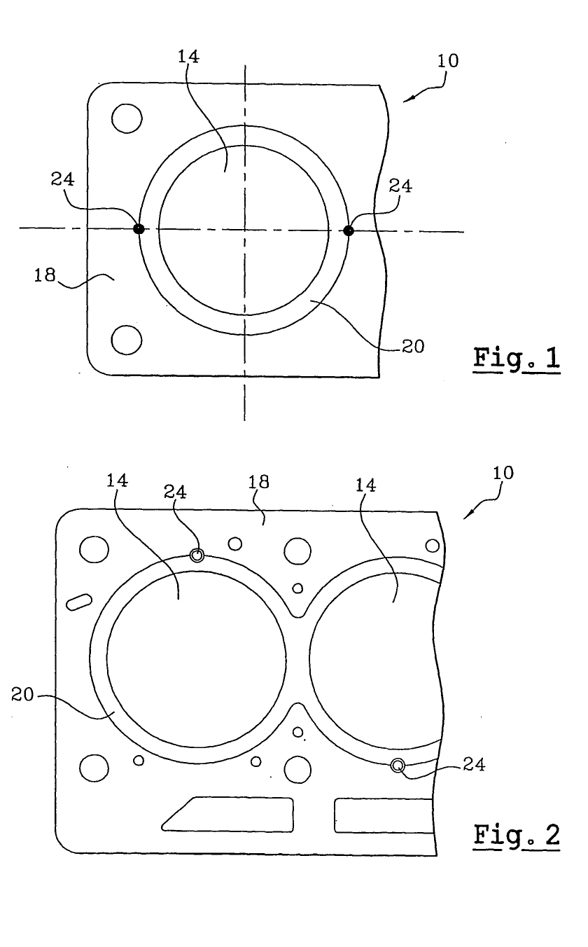

FIG. 1 is a plan view in cross-section of the support sheet of a monocylinder head gasket according to the invention,

FIG. 2 is a plan view in cross-section of the support sheet of a multicylinder head gasket according to a first variant of the invention,

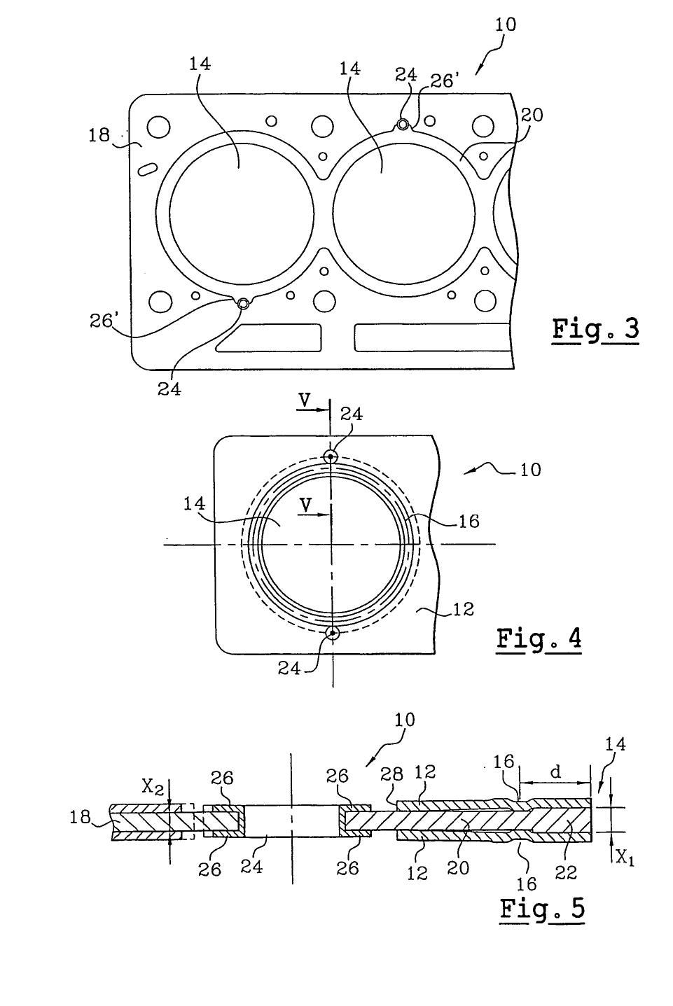

FIG. 3 is a plan view in cross-section of the support sheet of a multicylinder head gasket according to another variant,

FIG. 4 is a top view in elevation of a cylinder head gasket according to the invention, and

FIG. 5 is an enlarged cross-sectional view along line V-V of FIG. 4.

In the drawings is shown a cylinder head gasket 10 comprising at least one external sheet 12, and preferably two as illustrated in FIG. 5, with at least one opening 14 corresponding to a combustion chamber of an engine block, at least one of the external sheets 12, and preferably both, comprising a circular rib 16 that surrounds opening 14 and is disposed at a distance d from the edge of opening 14, the rib or ribs being deformed toward the inside of the gasket.

In a known manner, the intermediate support sheet 18 is interposed between the external sheets 12. In the case where the gasket contains only one external sheet 12, the support sheet 18 is disposed against the face of the external sheet 12 on which is provided the protruding rib.

The support sheet comprises an opening that is concentric with opening 14 of the external sheet or sheets 12 and has a diameter greater than opening 14 so as to define a space wherein is disposed stopper 20 in the form of an annular lining and having an internal diameter corresponding to that of opening 14 and an external diameter approximately adjusted to the opening of the support sheet.

Said stopper comprises at least one zone 22 of thickness X1 greater than thickness X2 of the support sheet so as to constitute a limiter against the crushing of the ribs, a first tightness barrier, and to permit the arching of at least one external sheet 12 so as to limit the deflections of the said sheet during operation.

Depending on the case, the external diameter of stopper 20 can be smaller than that of ribs 16 so that support sheet 18 fits between ribs 16, or it can be greater than that of ribs 16 so that a zone of said stopper of thickness less than X1 fits between ribs 16 as illustrated in FIG. 5.

The advantage of said last variant is that a piece of relatively high accuracy, the stopper being perfectly calibrated, fits between ribs 16 which results in a reduced intercylinder distance between openings 12 because of the fact that only stopper 20 is disposed between said openings 12.

Stopper 20 can be of the metallic type or made of fibrous material as described in patent application FR-01.06129 filed in the name of Applicant.

According to another feature, the stopper can have a tapered profile along its periphery. Thus, its thickness can be varied so as to obtain a constant contact pressure in spite of localized compressive forces.

According to the invention, stopper 20 is connected to the support sheet 18 by an element 24 that is interposed between said pieces.

Preferably, element 24 has a cylindrical shape like a pin or a rivet and is distinct from the stopper and the support sheet.

According to a preferred embodiment illustrated in FIG. 5, one or several rivets of the open type, known as eyelets, are used, said rivets having at each end a rim 26 which is folded against the faces of support sheet 18 and stopper 20 gripping them.

In this case, it is not necessary to use force to push the rivet or rivets between stopper 20 and support sheet 18, these elements being connected to each other by rims 26 that limit the relative movements between these two elements 18, 20.

This design allows one to obtain a stopper/support sheet connection that is less rigid than the prior-art designs based on welding or gluing and improves the operation of the cylinder head gasket. This arrangement permits the stopper to move relative to the other sheets thus permitting the gasket better to adapt itself to the compressive forces that inevitably are different depending on the zones considered.

According to a first variant illustrated in FIGS. 1, 2 and 4, rivet 24 is disposed directly between stopper 20 and support sheet 18 without the profile of these two elements being modified in any way.

According to a second variant illustrated in FIG. 3, rivet 24 is disposed at the level of a tab 26′ provided at the periphery of stopper 20. The main advantage of said tab 26′ is that rotation indexing of stopper 20 is obtained relative to the remainder of the gasket, particularly when said gasket has a tapered profile along its circumference. It will be understood that other indexing means can be used in place of the tabs to position the stopper by rotation.

Moreover, this arrangement provides greater amplitude of movement of stopper 20 relative to support sheet 18 thus improving the efficacy of said stopper.

In all cases, the thickness of rivet 24 is less than the total thickness of the cylinder head gasket, and apertures 28 are provided at the level of external sheets 12 opposite rivets 24 so that the assembly does not interfere with the proper functioning of the gasket.

The number of rivets needed to support the stopper will be chosen by those skilled in the art so as to ensure proper support for stopper 20.

For a simple ring, it will preferably be necessary to provide two diametrically opposed rivets.

In the case that the stoppers are connected to each other in an intercylinder zone as illustrated in FIGS. 2 and 3, one rivet per cylinder can suffice, the rivets being disposed in a staggered fashion.

According to another variant, element 24 that is interposed between stopper 20 and support sheet 18 can be in the form of a pin forced in to ensure a firm connection between the stopper and said sheet.

It will be understood that the invention is obviously not limited to the embodiments described hereinabove, but that, on the contrary, it covers all variants, particularly those concerning the profile of the stopper, the materials used, the fabrication of the sheets, each of which can consist of a stack of sheets, and the profiles and positions of the ribs.

1. Cylinder head gasket with at least one opening (14) corresponding to a combustion chamber and comprising, on the one hand, a sheet (12) referred to as the external sheet and comprising a circular rib (16) that surrounds the opening (14) and is disposed at a distance from the edge of said opening (14) and, on the other hand, a support sheet (18) disposed against the face of the external sheet (12) bearing the protruding rib (16) and comprising an opening of diameter greater than the opening (14) of the external sheet so as to define a space within which is disposed a stopper (20) in the form of an annular lining having an internal diameter that corresponds to that of the opening (14) and an external diameter approximately adjusted to the opening of the support sheet so as to be disposed from edge to edge, characterized in that said cylinder head gasket comprises an element (24) that is interposed between the stopper (20) and the support sheet ensuring the support of said stopper.

2. Cylinder head gasket with at least one opening (14) corresponding to a combustion chamber and comprising, on the one hand, at least two sheets (12) referred to as the external sheets at least one of which comprises a circular rib (16) that surrounds the opening (14) and is disposed at a distance from the edge of said opening (14) and, on the other hand, a support sheet (18) disposed between the external sheets (12) and comprising an opening of a diameter greater than the opening (14) of the external sheets so as to define a space wherein is disposed a stopper (20) in the form of an annular lining having an internal diameter that corresponds to that of the opening (14) and an external diameter approximately adjusted to the opening of the support sheet so as to be disposed from edge to edge, characterized in that said cylinder head gasket comprises an element (24) that is interposed between the stopper (20) and the support sheet ensuring the support of said stopper.

3. Cylinder head gasket according to claim 1 or 2, characterized in that the element (24) interposed between the stopper (20) and the support sheet (18) is in the form of a rivet comprising at each end a rim (26) folded against the faces of the support sheet (18) and the stopper (20) so as to grip them and to limit their relative movements.

4. Cylinder head gasket according to claim 3, characterized in that an aperture (28) is provided at the level of the external sheet or sheets (12) opposite each rivet (24).

5. Cylinder head gasket according to claim 3 or 4, characterized in that the thickness of the rivet (24) is less than the total thickness of the cylinder head gasket.

6. Cylinder head gasket according to any one of claims 1 to 5, characterized in that the stopper (18) [sic—“(20)” seems to be meant—Translator] comprises at the periphery thereof at least one tab (26′) at the level of which is disposed the support element (24).

7. Cylinder head gasket according to claim 1 or 2, characterized in that a forced-in pin is interposed between the stopper (20) and the support sheet (18).
